(19) United States
(12) Patent Application Publication
(10) Pub. No.: US 2006/0248221 A1
(43) Pub. Date: Nov. 2, 2006

(54) Method and apparatus for dual-mode internet protocol station/gateway

(76) Inventors: Andrew Hottel, Bartlett, IL (US); Thomas Pravongviengkham, Elgin, IL (US); Martin Camins, Waterloo (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/116,284

(22) Filed: Apr. 28, 2005

(51) Int. Cl. G06F 15/173

(52) U.S. Cl. 709/238

(57) ABSTRACT

A communications device is provided that includes a router and a local interface. The communications device also supports a plurality of remote interfaces. The remote interfaces are daisy-chain wired to the communications device and a plurality of communications devices may be operably connected to each other using an Internet Protocol network to form a communications system. The communications system may be used as part of a nurse call system. Also, methods that may be implemented by the above device and system are provided.

### FIELD OF THE INVENTION

The present invention relates generally to communications devices and systems. The present invention also relates to methods of operating such devices and systems.

### BACKGROUND OF THE INVENTION

Nurse call systems are designed to allow patients to contact nurses without having to get out of their hospital beds. FIG. 1 is a block diagram of a nurse call system 2 according to the prior art. Nurse call system 2 includes a plurality of patient interfaces 4, a nurses' station interface 6 and a Central Processing Engine (CPE) 8 to which interfaces 4 and 6 are all directly wired (i.e., home-run wired). Each patient interface 4 is located next to a different patient's hospital bed and nurses' station interface 6 is located at a central nurses' station.

Nurses' station interface 6 includes a call display, handset, speaker and microphone and each patient interface 4 includes a call button, a speaker and a microphone, with an optional connected call-cord or pillow speaker. When a patient requires a nurse's assistance, he pushes the call button on the patient interface 4 next to his bed, the call cord or the pillow speaker. This action signals the CPE 8 that the patient desires a nurse's attention.

Upon receipt of this signal, CPE 8 signals nurses' station interface 6, which annunciates and displays the patient call on nurses' station interface 6. Once a nurse answers the call, CPE 8 activates or routes the audio between the appropriate patient interface 4 and the nurses' station interface 6. This allows the patient and nurse to communicate with each other in a manner that is analogous to using an intercom system. CPE 8 then directs and supports all communication between the patient and nurse until the call is ended.

Nurse call systems according to the prior art allow patients to communicate from their hospital beds with nurses who are located at a central nurses' station. In the prior art nurse call system 2 illustrated in FIG. 1, a plurality of nodes 4 are distributed throughout a hospital, each node 4 being located in a different patient's room and being home-run wired to Central Processing Engine (CPE) 8. A nurses' station node 6 is located at the nurses' station and is also home-run wired to Central Processing Engine (CPE) 8.

In order to reduce the overall cost of system 2, the nurses' station interface 6 and each patient interface 4 in system 2 has only limited intelligence and memory. As such, each patient interface 4 is dependent upon the intelligence and memory of CPE 8 in order to communicate with nurses' station interface 6.

In view of the fact that CPE 8 is called upon in system 2 to perform so many tasks, CPE 8 is typically a complex and expensive piece of equipment. Also, by virtue of the design of system 2, the single CPE 8 is central to system 2. Therefore, if CPE 8 breaks down, none of the patient interfaces 4 may communicate with nurses' station interface 6. Further, since nurses' station interface 6 and each patient interface 4 is home-run wired to CPE 8, adding, subtracting or changing the location of any of the patient interfaces 4 in system 2 is typically costly and inconvenient.

In view of the above, it would be desirable to replace CPE 8 with one or more less expensive and/or complex devices. Also, it would desirable to provide some redundancy in system 2, instead of being susceptible to CPE 8 errors affecting the entire system 2. Even further, it would be desirable to replace the home-run wiring in system 2, at least to some extent, with more easily re-configurable connections, such as Ethernet connections.

### SUMMARY OF THE INVENTION

The foregoing needs are met, to a great extent, by the present invention wherein, in one embodiment thereof, a communications device is provided. The device includes a router configured to distribute audio signals to and from a remote interface, to distribute power to the remote interface, to accommodate remote audio communication with the remote interface via a non-Internet Protocol (IP)-based protocol and to accommodate communication with an IP-based network. The device also includes a local interface configured to support local audio communication at the communications device.

According to another embodiment of the present invention, a communications system is provided. The system includes a remote interface and a first communications device. The first communications device includes a router configured to distribute audio signals to and from the remote interface, to distribute power to the remote interface, to accommodate remote audio communication with the remote interface via a non-IP-based protocol and to accommodate communication with and IP-based network. The first communications device also includes a local interface configured to support local audio communication at the first communications device.

According to yet another embodiment of the present invention, a communications method is provided. The method includes transferring audio signals between a remote interface and a first communications device using a non-IP-based protocol. The method also includes providing power to the remote interface from the first communications device. The method further includes transferring the audio signal between the first communications device and a second communications device using an IP-based protocol. In addition, the method includes allowing a local interface that is attached to the first communications device to transfer the audio signals with the first communications device.

In addition, according to yet another embodiment of the present invention, another communications device is provided. The device includes local interfacing means for supporting local audio communication. The device also includes remote interfacing means for supporting remote audio communication. Further, the device includes routing means for distributing audios signals and power to the remote interfacing means. The routing means is also for accommodating remote audio communication with the remote interfacing means via a non-IP-based protocol. Further, the routing means is for accommodating communication with an IP-based network.

There has thus been outlined, rather broadly, certain embodiments of the invention in order that the detailed description thereof herein maybe better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a nurse call system according to the prior art;

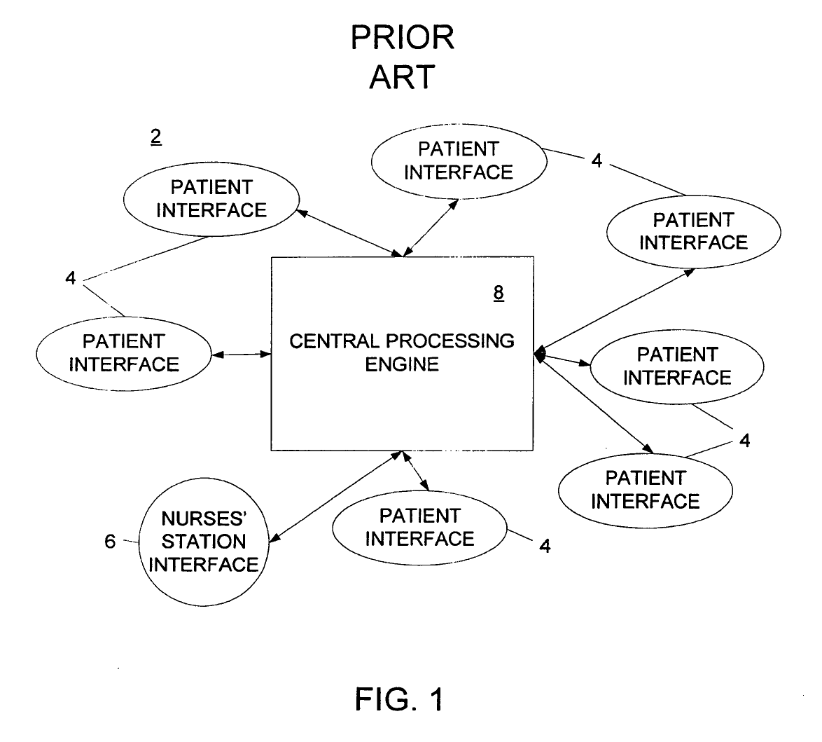

FIG. 2 is a block diagram of a communications system according to an embodiment of the present invention;

FIG. 3 is a circuit diagram that illustrates components included in a communications system according to yet another embodiment of the present invention;

FIG. 4 is a flow chart that illustrates the steps of a method according to still another embodiment of the present invention; and

FIG. 5 is a block diagram of a communications device according to an embodiment of the present invention.

### DETAILED DESCRIPTION

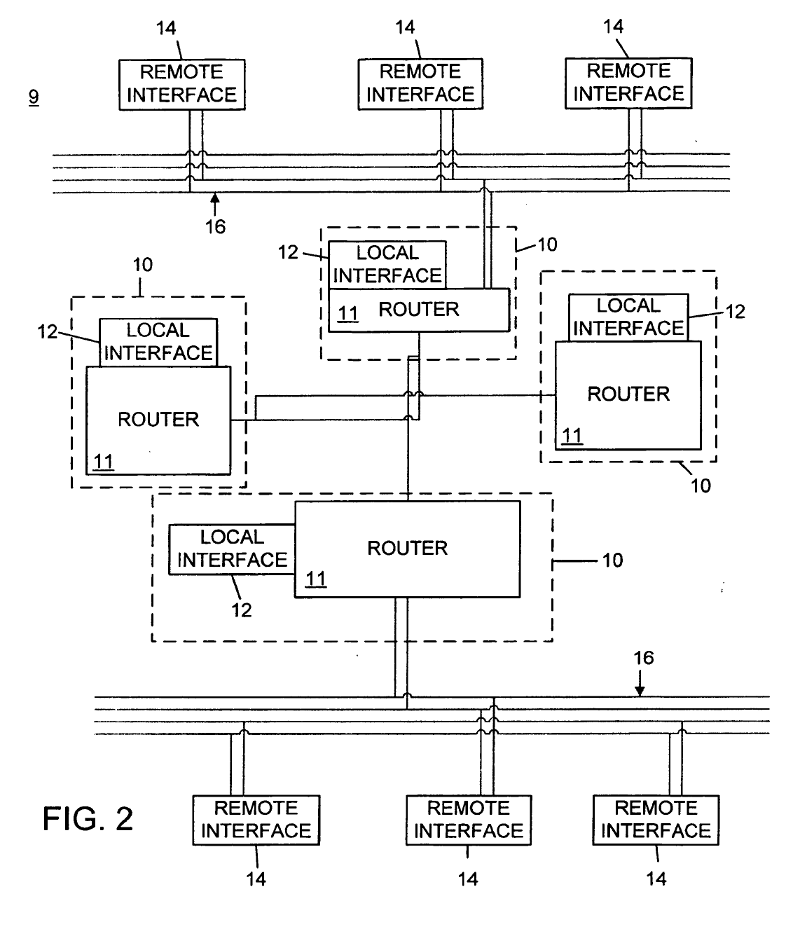

The present invention will now be described with reference to the drawing figures, in which like reference numerals refer to like parts throughout. FIG. 2 is a block diagram of a communications system 9 according to an embodiment of the present invention. This and other embodiments of the present invention directly address the shortcomings of nurse call systems according to the prior art.

Communications system 9 includes a plurality of communications devices 10 that each include a router 11 and a local interface 12. Communications system 9 also includes a plurality of remote interfaces 14. The communications devices 10 are operably connected to each other and each remote interface 14 is operably connected to an audio bus 16, which in turn is operably connected to a communications device 10.

Each router 11 illustrated in FIG. 2 is configured to distribute audio signals to and from at least one remote interface 14. The router 11 illustrated at the bottom of FIG. 2 distributes audio signals only to the three remote interfaces 14 illustrated at the bottom of FIG. 2. Although audio bus 16 is typically used to distribute the audio signals, the router 11 at the bottom of FIG. 2 can communicate directly with the remote interfaces 14 at the bottom of FIG. 2 (i.e., without having to route the audio signals through another communications device 10).

The router 11 illustrated at the top of FIG. 2 only distributes audio signals directly to the three remote interfaces 14 illustrated at the top of FIG. 2. The two remaining communications devices 10 illustrated in FIG. 2 are also configured to distribute audio signals directly to remote interfaces 14, typically using audio busses 16. However, neither those remote interfaces 14 nor audio busses 16 are illustrated in FIG. 2.

In addition to audio signals, each of the routers 11 illustrated in FIG. 2 may also be configured to distribute power to one or more remote interfaces 14. Typically, if a router 11 is configured to distribute audio signals directly to a remote interface 14, the router 11 is also be configured to distribute power to that interface 14.

Typically, each router 11 is configured to accommodate remote audio communication with one or more remote interfaces 14 using a non-Internet Protocol (IP)-based protocol. In other words, a router 11 is typically configured either to accommodate analog-based audio communication between itself and a remote interface 14 or is configured to accommodate a proprietary communications protocol.

Each of the routers 11 illustrated in FIG. 2 is also usually configured to accommodate communication with an IP-based network. In FIG. 2, the IP-based network is illustrated by the four routers 11 and the connections therebetween. By using such an IP-based network, voice over IP packets, as well as data packets and any other packets normally supported by an IP-based network, may be sent between each of the routers 11. Once the packets reach a destination router 11, the destination router can convert the information in the packet into a format that can be forwarded to a remote interface 14 that is operably connected to the destination router 11.

Local interfaces 12 are each usually directly connected to a router 11 in a communications device 10 and are typically configured to support local audio communication at the location of the communications device 10. Therefore, when network 9 takes the form of a nurse call system, in addition to using a remote interface 14 to communicate with a nurse or hospital staff member, a patient may also use a local interface 12, provided that a communications device 10 is proximate to the patient's location. It is also possible for a nurse or hospital staff member to use a local interface 12 to communicate with either patients or other staff members.

Typically, each local interface 12 and remote interface 14 includes one or more of a microphone, a speaker, an input/output device (e.g., a call button or a switch) and any other component that allows for communication over a communications network. Also, at least one local interface 12 that is equipped with a handset and display is typically located at a nurses' station. Therefore, according to certain embodiment of the present invention a patient may use either a local interface 12 or a remote interface 14 to communicate with a nurse or other hospital staff member in a manner that is analogous to using an intercom system.

Although local interfaces 12 are illustrated as being attached to routers 11 in FIG. 2, local interfaces 12 may be positioned anywhere in a communications device 10 or within reasonable proximity thereof. In nurse call systems, local interfaces 12 are typically positioned in the same room as a communications device 10. However, a wireless or cable connection to the device 10 may be used.

Each router 11 in FIG. 2 is usually configured to distribute at least one of audio signals, power and data. Audio signals and data may be distributed to either local interfaces 12 or remote interfaces 14 and power if typically distributed to remote interfaces 14. Further, each router 11 is typically configured to receive audio signals and/or data from either a local interface 12, a remote interface 14 or another router 11.

In addition to the above, each router 11 is also usually configured to prioritize and switch audio signals and/or data signals for the local interface 12 and the plurality of remote interfaces 14 that are directly connected to the router 11. In other words, the router 11 is typically capable of selecting which audio signals or data streams should be transmitted first, second, etc. Further, router 11 is typically configured to perform at least one of decoding, packetization, echo-cancellation, jitter-buffering and filtering of audio signals and/or data streams.

According to certain embodiments of the present invention, each remote interface 14 is a “thin” device that includes very little processing capability or memory. The use of “thin” devices typically reduces the overall cost of a network. However, it also usually makes each remote interface 14 dependent upon the processing power and memory capacity of an external device. According to certain embodiments of the present invention, the routers 11 are configured to provide/share at least one of memory capacity and processing power for the benefit of one or more remote interfaces 14. For example, if a first remote interface 14 that is directly connected to a first router 11 wishes to communicate with a second remote interface 14 that is directly connected to a second router 11, the first remote interface 14 may make use of network configuration data that is stored in the first router 11 to facilitate the communication.

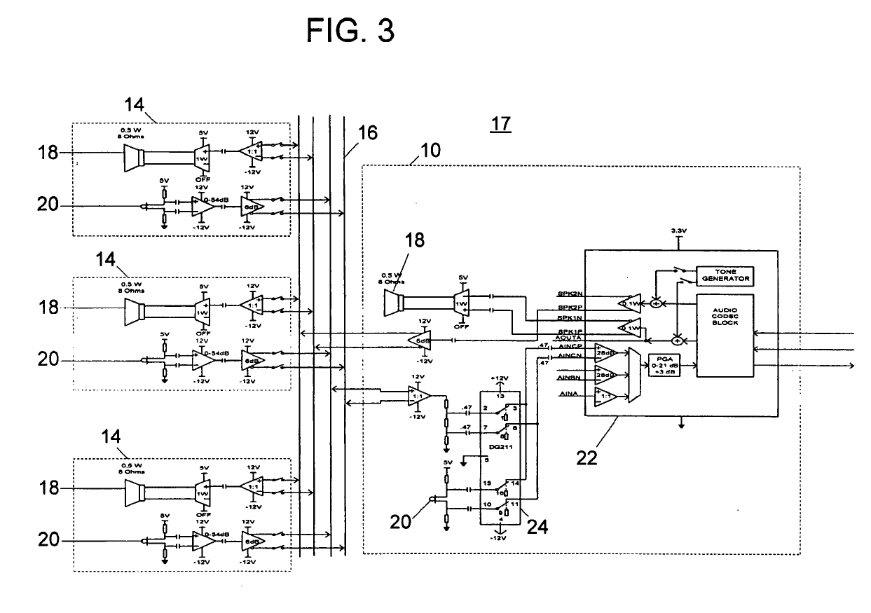

FIG. 3 is a circuit diagram that illustrates components included in a communications system 17 according to yet another embodiment of the present invention. Communications system 17 includes one communications device 10 and three remote interfaces 14 that are directly linked to communications device 10 via audio bus 16. Each remote interface 14 includes a number of amplifiers, a speaker 18 and a microphone 20. Communications device 10 also includes a speaker 18 and a microphone 20 as part of it's local interface. Device 10 further includes logic component 22 and switches 24 as part of its router. The logic component 22 may, for example, take the form of a microprocessor and the microprocessor typically includes a separate integrated DSP core.

It should be understood that the configuration illustrated in FIG. 3 is not particularly limiting of the present invention. As such, other circuit configurations and/or components may be used to implement the devices, systems and methods according to the present invention. For example, according to certain embodiments of the present invention, each remote interface 14 illustrated in FIG. 3 includes a microphone 18, a speaker 20 and another input/output device. Further, a remote interface 14 according to the present invention may include the simplest of processors and/or a small amount of memory. As such, each remote interface 14 may be relative simple and inexpensive.

In addition to using the buses 16 illustrated in FIGS. 2 and 3, a communications device 10 according to the present invention may distribute audio signals, data streams and/or power to remote interfaces 14 that are daisy-chain wired to it by using a single, multi-wire cable between remote interfaces 14. Also, according to certain embodiments of the present invention, at least one remote interface 14 and/or at least one local interface 12 is configured to support full-duplex audio signals.

Since the routers 11 illustrated in FIGS. 2 and 3 often have relative complex processor included in the routers 11 thereof, a router 11 typically controls the audio bus 16 to which it is connected. Also, it should be noted that although only an audio bus 16 is illustrated in FIGS. 2 and 3, other busses may be used according to the present invention and these busses may support data as well as audio.

Since buses according to the present invention are typically positioned between a router and one or more remote interfaces, the buses typically support protocols other than IP. In other words, buses may support analog signals or non-IP protocols. However, this is not particularly restrictive of the present invention.

As mentioned above, in the systems illustrated in FIGS. 2 and 3, the communications devices 10 typically communicate directly with remote interfaces 14 that are daisy-chain wired thereto. The communications devices 10 also usually communicate directly with other devices 10 in the system or network using IP packets. However, if a first communications device 10 wishes to communicate with a remote interface 14 that is not daisy-chain wired thereto, the communications device 10 must communicate indirectly (i.e., through a second communications device 10) therewith.

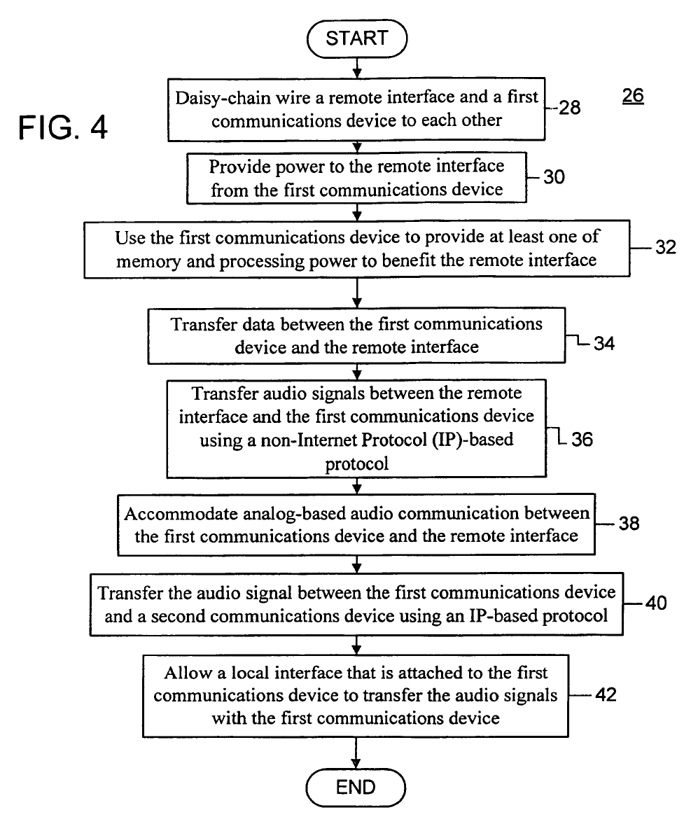

FIG. 4 is a flowchart 26 that illustrates the steps of a method according to still another embodiment of the present invention. As illustrated in FIG. 4, the first step 28 of flowchart 26 specifies daisy-chain wiring a remote interface and a first communications device to each other. Then step 30 specifies providing power to the remote interface from the first communications device. Following step 30, step 32 specifies using the first communications device to provide at least one of memory and processing power to benefit the remote interface.

Step 34 specifies transferring data between the first communications device and the remote interface. Then, step 36 specifies transferring audio signals between the remote interface and the first communications device using a non-IP-based protocol. Following step 36, step 38 specifies accommodating analog-based audio communication between the first communications device and the remote interface.

Step 40 specifies transferring the audio signal between the first communications device and a second communications device using an IP-based protocol. Then, step 42 specifies allowing a local interface that is attached to the first communications device to transfer the audio signals with the first communications device.

It will be appreciated by those of skill in the art that the representative method whose steps are illustrated in flowchart 26 may be implemented by systems and/or devices according to other embodiments of the present invention, including those illustrated in FIGS. 2 and 3.

According to another embodiment of the present invention, a communications device is provided that includes local interfacing means for supporting local audio communication. The local interfacing means may take the form of local interfaces 12 illustrated in FIGS. 2 and 3.

The communications device also includes a remote interfacing means that supports remote audio communication. Representative embodiments of such remote interfacing means are the remote interfaces 14 illustrated in FIGS. 2 and 3.

Also included in the communications device are routing means for distributing audio signal and power to the remote interfacing means. These routing means may also accommodate remote audio communication with the remote interfacing means via a non-IP-based protocol. Further, the routing means may accommodate communication with an IP-based network. The above-discussed routers 11 are one representative embodiment of such routing means according to the present invention.

It will be appreciated by those of skill in the art that a plurality of communications devices 10 may replace CPE's according to the prior art. As such, if one communications device 10 breaks down, many of the remote interfaces 14 in the network may still operate. Further, since the communications devices illustrated in FIGS. 2 and 3 are not home-run wired to each other, moving these devices 10 is relatively convenient and cost-effective. Even further, at least because each communications device 10 is called upon to support relatively few remote interfaces, communications devices 10 tend to be less complex and less expensive than traditional CPE's.

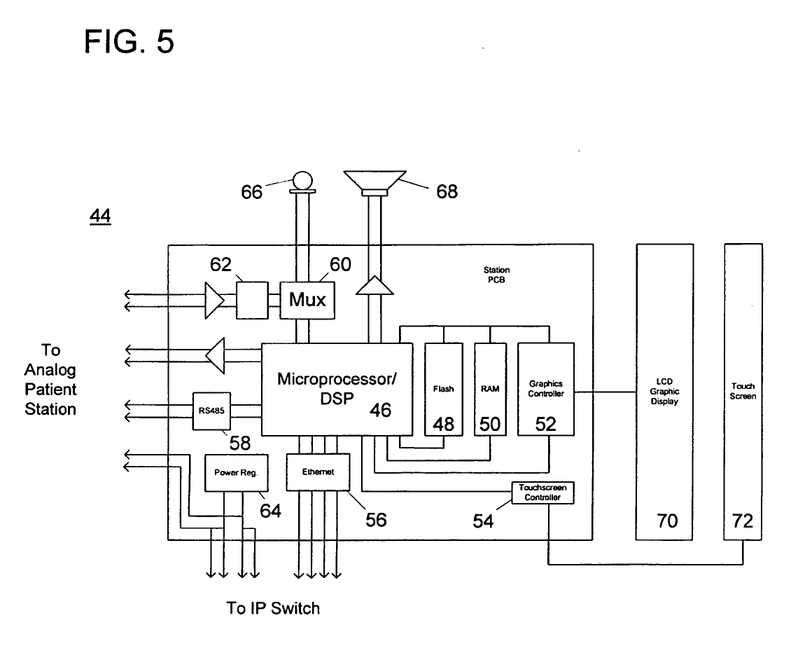

FIG. 5 is a block diagram of a communications device 44 according to an embodiment of the present invention. Device 44 includes multiplexer/Digital Signal Processor (DSP) 46, to which are operably connected flash memory 48, RAM memory 50 and graphics controller 52. Also operably connected to multiplexer/DSP 46 are touchscreen controller 54, Ethernet connection 56, RS485 connection 58, multiplexer 60 and module 62, which may, for example, take the form of a pre-amplifier, a buffer or a filter. Device 44 also includes power regulator 64, microphone 66, which is operably connected to multiplexer 60, and speaker 68, which is operably connected to multiplexer/DSP 46. Operably connected to graphics controller 52 are LCD graphics display 70 and touch screen 72. It should be noted that device 44 need not include all of the components illustrated therein to be within the scope of the present invention. Also, the components illustrated within device 44 may be rearranged and/or other components may be added according to other embodiments of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A communications device, the device comprising:
a router configured to distribute audio signals to and from a remote interface, to distribute power to the remote interface, to accommodate remote audio communication with the remote interface via a non-Internet Protocol (IP)-based protocol and to accommodate communication with an IP-based network; and
a local interface configured to support local audio communication at the communications device.

2. The communications device of claim 1, wherein the router is further configured to accommodate analog-based audio communication between the router and the remote interface.

3. The communications device of claim 1, wherein the router is further configured to distribute data to and from the remote interface.

4. The communications device of claim 1, wherein the router is further configured to prioritize and switch the audio signals for a plurality of remote interfaces.

5. The communications device of claim 1, wherein the router is further configured to perform at least one of decoding, packetization, echo-cancellation, jitter-buffering and filtering of the audio signals.

6. The communications device of claim 1, wherein the router is further configured to provide at least one of memory and processing power to benefit the remote interface.

7. The communications device of claim 1, wherein the router and the local interface are configured to be used in a nurse call system.

8. A communications system, the system comprising:
a remote interface; and
a first communications device, the first communications device including,
a router configured to distribute audio signals to and from the remote interface, to distribute power to the remote interface, to accommodate remote audio communication with the remote interface via a non-Internet Protocol (IP)-based protocol and to accommodate communication with an IP-based network; and
a local interface configured to support local audio communication at the first communications device.

9. The communications system of claim 8, wherein the remote interface comprises:
a microphone;
a speaker; and
an Input/Output device.

10. The communications system of claim 8, wherein the remote interface is daisy-chain wired to the communications device.

11. The communications system of claim 8, wherein at least one of the remote interface and the local interface is configured to support full-duplex audio signals.

12. The communications system of claim 11, wherein the remote interface is connected to the communications device by an audio bus and wherein the router controls the audio bus.

13. The communications system of claim 8, wherein the router is further configured to provide at least one of memory and processing power to benefit the remote interface

14. The communications system of claim 8, wherein the router is further configured to accommodate analog-based audio communication between the router and the remote interface.

15. The communications system of claim 8, further comprising:
a second communications device operably connected to the first communications device via the IP-based network, wherein the second communications device is configured to communicate directly with the first communications device and indirectly with the remote interface through the first communications device.

16. A communications method, the method comprising:
transferring audio signals between a remote interface and a first communications device using a non-Internet Protocol (IP)-based protocol;
providing power to the remote interface from the first communications device;
transferring the audio signal between the first communications device and a second communications device using an IP-based protocol; and
allowing a local interface that is attached to the first communications device to transfer the audio signals with the first communications device.

17. The communications method of claim 16, further comprising:
daisy-chain wiring the remote interface and the first communications device to each other.

18. The communications method of claim 16, further comprising:
accommodating analog-based audio communication between the first communications device and the remote interface.

19. The communications method of claim 16, further comprising:
transferring data between the first communications device and the remote interface.

20. The communications method of claim 16, further comprising:
using the first communications device to provide at least one of memory and processing power to benefit the remote interface.

21. A communications device, the device comprising:
local interfacing means for supporting local audio communication;
remote interfacing means for supporting remote audio communication; and
routing means for distributing audio signals and power to the remote interfacing means, for accommodating remote audio communication with the remote interfacing means via a non-Internet Protocol (IP)-based protocol, and for accommodating communication with an IP-based network.
